(19) United States
(12) Patent Application Publication
(10) Pub. No.: US 2008/0254418 A1
(43) Pub. Date: Oct. 16, 2008

(54) Corrective writing aid to facilitate proper grip

(76) Inventor: Anita H. Burke, New Brunswick, NJ (US)

Correspondence Address: Anita H. Burke, 347 Livingston Avenue, New Brunswick, NJ, 08901, US

(21) Appl. No.: 11/544,047

(22) Filed: Nov. 20, 2006

Related U.S. Application Data
(60) Provisional application No. 60/724,128, filed on Oct. 6, 2005.

(51) Int. Cl. G09B 11/02

(52) U.S. Cl. 434/166

(57) ABSTRACT

The present invention provides a hand held elongated writing aid to facilitate a mature tripod grasp. The writing aid comprises a writing tool, a string and an object. The string is attached to the upper end of the writing tool, and the object is attached to the other end of the string. By holding the object between the fourth and fifth digits, the student is induced to hold the writing tool between the thumb and second and third digit.

### BACKGROUND OF THE INVENTION

The present invention relates to a writing aid, and more particularly to an improved writing grasp for aiding persons in holding a pencil or other writing tools with a mature tripod grasp.

A person first learning to hold a writing tool will developmentally hold all writing tools improperly. A person may require some implementation or special device to facilitate the grasp in order to properly grip a writing tool.

### SUMMARY OF THE INVENTION

In accordance with the present invention, a hand held elongated writing aid, where the writing aid comprises a writing tool, a string and an object. The string is attached to the upper end of the writing tool. The object is attached to the other end of the string. By holding the object between the fourth and fifth digits, the student is induced to hold the writing tool between the thumb and second and third digit.

These and other features of this invention and their inherent advantages will become apparent to those skilled in the art from the following description of preferred embodiments and the accompanying drawings illustrating the best mode of carrying out the invention as presently perceived.

### BRIEF DESCRIPTION OF THE FIGURES

FIG. 1 is a front view of the present invention.

### DETAILED DESCRIPTION OF THE INVENTION

The present invention provides a hand held elongated writing aid to facilitate a mature tripod grasp. The writing aid comprises a writing tool, a string and an object. The string is attached to the upper end of the writing tool, and the object is attached to the other end of the string. By holding the object between the fourth and fifth digits, the student is induced to hold the writing tool between the thumb and second and third digit.

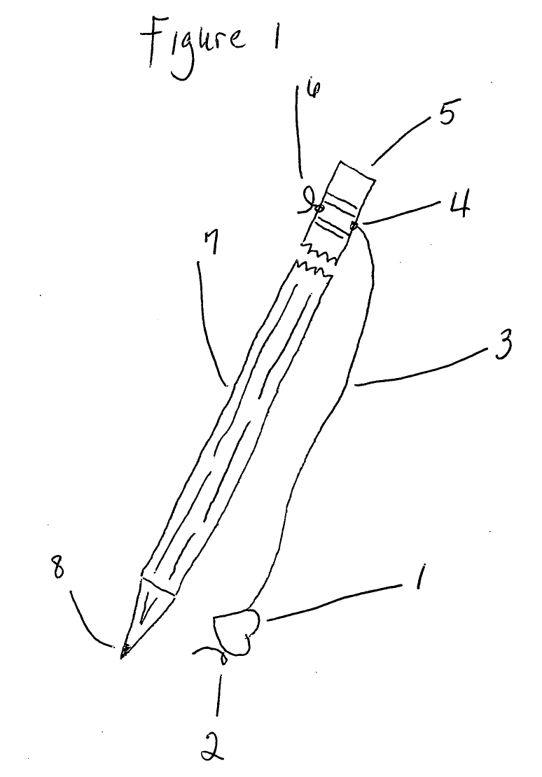

The illustration of the writing aid of the present invention is shown in FIG. 1. The writing tool 7 is designed to be held between the thumb and first and second digits on the shaft of the writing tool 7 while the object 1 is held with the fourth and fifth digits against the palm of the hand. The objective of holding the object is to facilitate isolation of the two sides of the hand assisting in proper positioning of a mature tripod grasp.

One end of the string 3 is attached to the upper end of the writing tool. The string 3 may be attached by any means, fixably (e.g. length of the string is not adjustable by user) or adjustably (e.g. length of the string may be adjusted by user). In one embodiment, the string 3 is attached through a bore hole 4 drilled through the shaft of the writing tool. The string is held secure by, for example, a knot 6. Alternatively, the string may be secured using a bead or adjustable clamp, which may be fixed or slidably attached to the string allowing the length of the string to be adjusted to accommodate the user. Thus, the bead may have an inner diameter slightly smaller than the outside diameter of the string to allow it to be slidably attached, and an outer diameter or size larger than the bore hole so as to hold the string in place. The object 1 is attached to the string 3 using a knot, bead, adjustable clamp or other attachment means 2 at other end of string. The length 3 of the string is sufficient to allow for proper gripping of the object 1 between the fourth and fifth digits. In one embodiment, the string is approximately the length of the writing tool. The string 3 length can be adjusted pulling the string through the bore hole 4 or through the object 1, or both, and resecuring (e.g., by retying the knot or adjusting the clamp or bead). As will be apparent, the writing aid may be used in either the left or right hand.

The writing tool 7 may be any writing instrument including, for example, pens, pencils of various diameters and sizes, crayons, paint brushes the like. The type of string used to attach object can be of various material or textures including leather, lacing material, beading material, and the like. The color of the string can consist of various colors including neon colors, rainbow colors and prime colors.

The object 1 can be of various size, texture, shape or color. Preferably, the object is of a shape and size that is comfortably held between the fourth and fifth digits and the palm of the hand. Preferably, the object has a cross-section of less than about 1 inch. To facilitate use among younger students, the object may be a trinket or charm of various types such as sports, animals, alphabet letters, vehicles, faces, hearts, beads, etc.

Although the invention has been described in detail with reference to the illustrated preferred embodiments, variations and modifications exist within the scope and spirit of the invention as described.

I claim:

1. A writing aid to facilitate a mature tripod grasp comprising a writing tool, a string and an object, wherein the string is attached to the upper end of the writing tool, and the object is attached to the other end of the string.

2. The writing aid of claim 1 wherein the writing tool is slidably attached to the string wherein the length of the string is adjustable.

3. The writing aid of claim 1 wherein the string is approximately the length of the writing tool.

4. The writing tool of claim 1 wherein the object is slidably attached to the string.

5. A method of facilitating a mature tripod grasp comprising using the writing aid of claim 1.

6. The method of claim 5 wherein the method further comprises holding the object against the palm with the fourth and fifth digits, and holding the writing tool between the thumb and second and third digit.
